(19) United States
(12) Patent Application Publication
(10) Pub. No.: US 2017/0080852 A1
(43) Pub. Date: Mar. 23, 2017

(54) A REAR LIGHT SYSTEM FOR A TOWABLE VEHICLE

(71) Applicant: Patrick Joseph SHANAHAN, County Tipperary (IE)

(72) Inventors: Patrick Joseph SHANAHAN, County Tipperary (IE); Ariel BOROSZKO, County Tipperary (IE)

(21) Appl. No.: 15/311,422

(22) PCT Filed: May 15, 2015
(86) PCT No.: PCT/IE2015/000006

§ 371 Date: Nov. 15, 2016

(30) Foreign Application Priority Data
May 15, 2014 (IE) S2014/0124

(51) Int. Cl. B60Q 1/30; F21S 8/10; B60Q 1/44; B60Q 1/34; H05B 37/02

(52) U.S. Cl. CPC B60Q 1/305; B60Q 1/34; H05B 37/0272; B60Q 1/44; F21S 48/215; B60Q 2900/30; F21Y 2115/10

(57) ABSTRACT

A rear light system for a trailer includes a primary housing typically located in a prime mover which tows the trailer, and a right- and left-hand sub-housings for mounting on a rear panel of the trailer. The sub-housings include first light sources to produce turning direction light signals, second light sources to produce braking light signals, third light sources to form tail lights, and fourth light sources for illuminating a license number plate. A primary controller connected to the CAN bus of the prime mover detects signals indicative of activation of the direction indicators, braking and tail lights, and transmits signals by a wireless transmitter in the primary housing to wireless receivers in the respective right-hand and left-hand sub-housings. A secondary controller reads signals received by the wireless receiver, and on detecting appropriate signals activates the appropriate ones of the light sources.

The present invention relates to a rear light system for a towable vehicle, and in particular, for a towable vehicle of the type which is typically towed by a prime mover, for example, a road vehicle such as a motor car, a van, a truck, a tractor unit of an articulated vehicle, an agricultural tractor or other such motive vehicle. The towable vehicle may, for example, be a trailer, a horsebox, a caravan, or other such towable vehicle.

In order to comply with both safety and regulatory requirements, it is necessary to provide lights on the rear of a trailer or other towable vehicle being towed by a prime mover, firstly so that the towable vehicle will be visible to following traffic, and secondly, to give an indication to following traffic of braking of the prime mover and the towable vehicle, and also to give an indication of the direction in which it is intended to turn the prime mover and the towable vehicle. In general, such lights are provided on a panel which includes left-hand and right-hand direction indicator lights which are located typically at the extremities of the panel on respective opposite sides thereof, brake lights and tail lights, both of which are also located at the respective opposite extremities of the panel. A central area on the panel between the brake lights is provided for receiving a number plate. Typically, a light is also provided for illuminating the number plate.

Such panels are hardwired into the wiring circuit of the prime mover. This, thus, requires a loom of wires extending from the panel for providing power to the respective lights in the panel, and the loom of wires typically terminates in a plug which is engageable with a socket. The socket is typically mounted on a bracket adjacent a ball hitch to which the towable vehicle is coupled. Such arrangements of providing lights for attaching to the rear of a towable vehicle have a large number of disadvantages. Firstly, the fact that the panels must be hardwired into the electrical circuitry of the prime mover requires wires trailing between the rear panel which is adapted for mounting to the rear of the towable vehicle and the socket of the prime mover into which the plug of the wire loom from the rear panel is to be connected. Since towable vehicles are of varying length, and indeed, are of length which ranges over a wide range of dimensions, for example, from the smallest trailer which may be no more than one metre long, to a large horsebox or a caravan which could be up to six metres long, and indeed longer. This, thus, requires that the wire loom for connecting the rear panel to the socket of the prime mover must be relatively long, and where such a rear light system is being used on a relatively short trailer, there is a danger of a part of the wiring loom becoming loose and trailing along a road surface, and thus leading to wear and indeed breaking of the electrical continuity in the wiring loom between the rear panel and the plug. This is undesirable, and there is therefore a need for a rear light system which addresses these problems.

The present invention is directed towards providing a rear light system for a towable vehicle.

According to the invention there is provided a rear light system for a towable vehicle, the rear light system comprising a primary controller for locating in a prime mover by which the towable vehicle is being towed, the primary controller being configured to receive signals indicative of activation of a direction indicator of the prime mover, a wireless transmitter for locating in the prime mover and being configured to wirelessly transmit a direction indicator active signal under the control of the primary controller, a pair of first output elements adapted for mounting adjacent the rear of the towable vehicle spaced apart from each other and being configured to output a visually perceptible signal, a wireless receiver adapted for locating on the towable vehicle and being configured to wirelessly receive a direction indicator active signal transmitted by the transmitter, a secondary controller for locating on the towable vehicle and being configured to read a received direction indicator active signal from the receiver and to selectively activate the appropriate one of the first elements in response to the received signal.

In one aspect of the invention at least one second output element is provided adapted for mounting adjacent the rear of the towable vehicle and configured to output a visually perceptible signal.

Preferably, the primary controller is configured to receive a signal indicative of braking of the prime mover, and the secondary controller is responsive to a signal read from the wireless receiver to activate the second output means.

Advantageously, the primary controller is configured to receive the signal indicative of braking of the prime mover from a CAN bus of the prime mover.

In one aspect of the invention the primary controller is configured to receive the signal indicative of braking of the prime mover from a motion sensor located in the prime mover. Preferably, the motion sensor is provided and is electrically coupled to the primary controller.

In another aspect of the invention the primary controller is configured to receive the signal indicative of braking of the prime mover from a pedal state sensor operably connected to a brake pedal of the prime mover. Preferably, the pedal state sensor is provided and is electrically coupled to the primary controller.

In a further aspect of the invention the primary controller is configured to receive the signal indicative of braking of the prime mover from a power signal derived from a brake light circuit of the prime mover.

Preferably, the primary controller is responsive to the received signal indicative of braking of the prime mover to produce a braking active signal, and to operate the wireless transmitter to transmit the braking active signal. Advantageously, the secondary controller is responsive to the braking active signal to activate the second output element to output the visually perceptible signal.

In one aspect of the invention the primary controller is responsive to ceasing of the signal indicative of braking of the prime mover to produce a braking ceased signal, and to operate the wireless transmitter to transmit the braking ceased signal. Preferably, the secondary controller is responsive to the braking ceased signal to deactivate the second output element.

Preferably, the primary controller is configured to receive the signal indicative of activation of a direction indicator of the prime mover from a CAN bus of the prime mover.

In one aspect of the invention the primary controller is configured to receive the signal indicative of activation of a direction indicator of the prime mover from an operating arm state sensor mounted on an operating arm of a direction indicator switch of the prime mover. Preferably, the operating arm state sensor is provided, and is mounted on the operating arm of the direction indicator switch of the prime mover. Advantageously, the operating arm state sensor comprises an accelerometer. Ideally, the operating arm state sensor is electrically coupled to the primary controller.

In another aspect of the invention the primary controller is configured to receive the signal indicative of activation of a direction indicator of the prime mover from a power supply to the direction indicator of the prime mover.

Preferably, the primary controller is responsive to the received signal indicative of activation of a direction indicator of the prime mover to produce the direction indicator active signal, and to operate the wireless transmitter to transmit the direction indicator active signal. Advantageously, the secondary controller is responsive to the direction indicator active signal to activate one of the first output elements to output the visually perceptible signal.

In another aspect of the invention the primary controller is responsive to a signal indicative of the direction indicator of the prime mover being deactivated to produce a direction indicator ceased signal, and to operate the wireless transmitter to transmit the direction indicator ceased signal. Preferably, the secondary controller is responsive to the direction indicator ceased signal to deactivate the first output element.

In one aspect of the invention the primary controller is responsive to the received signal indicative of activation of a direction indicator of the prime mover to produce an identification signal identifying the direction indicator of the prime mover which has been activated, and to operate the wireless transmitter to transmit the identification signal. Preferably, the secondary controller is responsive to the identification signal to activate the appropriate one of the first output elements to output the visually perceptible signal.

In another aspect of the invention at least one third output element is provided and is adapted for locating adjacent the rear of the towable vehicle, the third output element being configured to output a visually perceptible signal.

In a further aspect of the invention at least one fourth output element is provided and is adapted for locating adjacent the rear of the towable vehicle and is configured to illuminate a panel adjacent the rear of the towable vehicle.

In another aspect of the invention the primary controller is configured to receive a signal indicative of activation of the tail lights of the prime mover, and the primary controller is responsive to the signal indicative of activation of the tail lights of the prime mover for producing a tail light active signal and for operating the wireless transmitter for transmitting the taillight active signal. Advantageously, the secondary controller is responsive to the tail light active signal for activating the third output element and the fourth output element.

Preferably, the primary controller is configured to receive the signal indicative of activation of the tail lights of the prime mover from the CAN bus of the prime mover. Alternatively, the primary controller is configured to receive the signal indicative of activation of the tail lights of the prime mover from a power signal derived from the tail light circuit of the prime mover.

In another aspect of the invention the primary controller is responsive to a signal indicative of deactivation of the tail lights for producing a tail light ceased signal and for operating the wireless transmitter for transmitting the tail light ceased signal. Preferably, the secondary controller is responsive to the tail light ceased signal for deactivating the third output element and the fourth output element.

Preferably, the wireless transmitter and the wireless receiver are configured to operate in a short range communications protocol. Advantageously, the wireless transmitter and the wireless receiver are configured to operate under the Wi-Fi protocol.

In another aspect of the invention a primary power source is provided for powering the primary controller and the wireless transmitter.

In a further aspect of the invention the primary power source comprises a power source independent of any power source of the prime mover.

In another aspect of the invention at least one secondary power source is provided for powering the first output elements, the secondary controller and the wireless receiver.

Preferably, the at least one secondary power source is provided for powering the second output element.

Advantageously, the at least one secondary power source is provided for powering the third and fourth output elements.

In one aspect of the invention at least one trailer mountable housing is provided, and the secondary controller and the wireless receiver are housed in the trailer mountable housing.

Preferably, the first output elements are housed in the trailer mountable housing.

Advantageously, the at least one second output element is housed in the trailer mountable housing.

Preferably, the third and fourth output elements are housed in the trailer mountable housing.

In another aspect of the invention the trailer mountable housing comprises a pair of sub-housings, and one of the first output elements is housed in each sub-housing.

Preferably, a pair of the second output elements are provided, and one of the second output elements is housed in each sub-housing.

Advantageously, a pair of the secondary controllers are provided and a pair of the secondary wireless receivers are provided, one of the secondary controllers and one of the wireless receivers being housed in each sub-housing.

Preferably, a pair of the third output elements are provided, one of the third elements being located in each sub-housing.

Advantageously, a pair of the fourth output elements is provided, each fourth output element being housed in one of the sub-housings.

In one aspect of the invention the sub-housings are adapted for mounting on the rear of the towable vehicle spaced apart from each other towards respective opposite sides of the towable vehicle. Preferably, each sub-housing is configured for releasable mounting on the towable vehicle.

In one aspect of the invention each first output element comprises a first light source. Preferably, each second output element comprises a second light source. Advantageously, each third output element comprises a third light source. Preferably, each fourth output element comprises a fourth light source.

The invention also provides a towable vehicle comprising the rear light system according to the invention.

Further the invention provides in combination a prime mover and a towable vehicle, the towable vehicle comprising the rear light system according to the invention and being hitched to the prime mover.

The invention will be more clearly understood from the following description of a preferred embodiment thereof, which is given by way of example only, with reference to the accompanying drawings, in which:

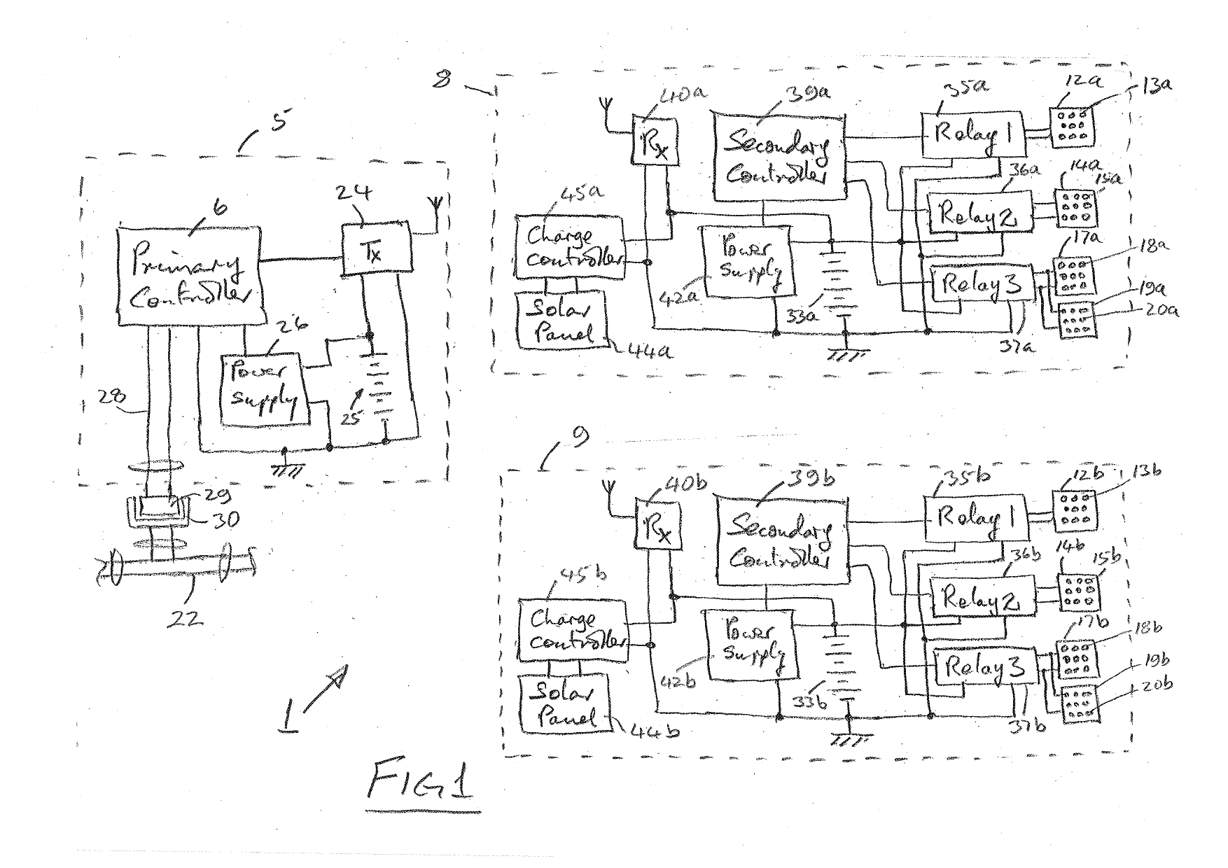

FIG. 1 is a block representation of a rear light system according to the invention for a towable vehicle, and

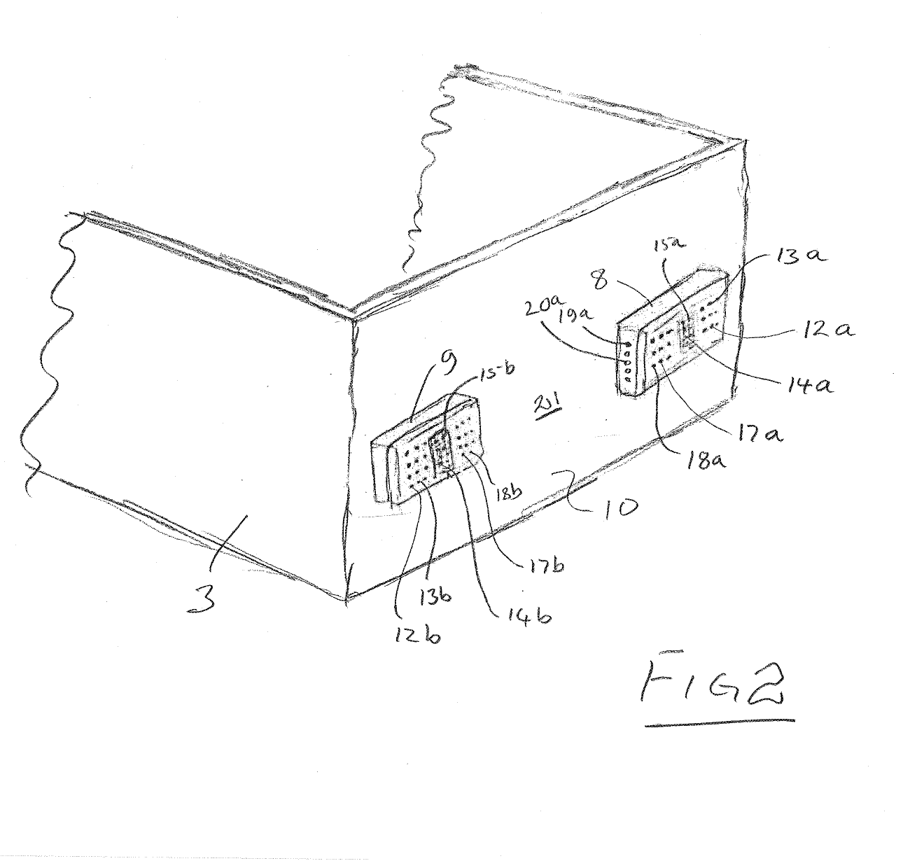

FIG. 2 is a perspective view of a portion of a towable vehicle with parts of the rear light system mounted thereon.

Referring to the drawings, there is illustrated a rear light system according to the invention, indicated generally by the reference numeral 1, for a towable vehicle also according to the invention, in this embodiment of the invention a trailer 3, a rear portion of which is illustrated in FIG. 2 hereof, which is suitable for towing by a prime mover (not shown) which may, for example, be a car, a van, a truck, a tractor or the like. The combination of the prime mover, the towable vehicle 3 and the rear light system 1 is also according to the invention. The rear light system 1 comprises a primary housing 5 which houses a primary controller 6, which will be described below, and a trailer mountable housing provided by a pair of sub-housings, namely, a right-hand sub-housing 8 and a left-hand sub-housing 9. The right-hand and left-hand sub-housings 8 and 9 are adapted for releasable mounting on a rear panel 10 of the trailer 3 towards respective opposite sides thereof. The primary housing 5 and the right-hand and left-hand sub-housings 8 and 9 are schematically illustrated in broken lines in FIG. 1, and the right-hand and left-hand sub-housings 8 and 9 are illustrated in FIG. 2.

The right-hand and left-hand sub-housings 8 and 9 comprise respective first output elements for outputting a visually perceptible signal, which in this case comprise respective first light sources 12, namely, a right-hand first light source 12a which is located in the right-hand sub-housing 8, and a left-hand first light source 12b which is located in the left-hand sub-housing 9. The right-hand and left-hand first light sources are provided as direction indicators for producing direction light signals indicative of the direction in which it is intended that the prime mover and the trailer 3 will turn. Each first light source 12 in this embodiment of the invention comprises a plurality of first light emitting diodes 13 for producing the direction light signals.

A pair of second output elements for outputting a visually perceptible signal, in this embodiment of the invention are provided by right-hand and left-hand second light sources 14a and 14b located in the right-hand and left-hand sub-housings 8 and 9, respectively. The right-hand and left-hand light sources 14a and 14b are provided for producing a braking light signal indicative of brakes of the prime mover, and possibly, although not necessarily, the brakes of the trailer 3, being applied. Each second light source 14 comprises a plurality of second light emitting diodes 15 for producing the braking light signal.

A pair of third output elements for producing visually perceptible signals comprising respective right-hand and left-hand third light sources 17a and 17b are located in the right-hand and left-hand sub-housings 8 and 9, respectively, to act as tail lights for the trailer 3. Each third light source 17 comprises a plurality of third light emitting diodes 18 to form the tail lights of the trailer 3.

A pair of fourth output elements for producing visually perceptible signals comprising respective right-hand and left-hand fourth light sources 19a and 19b are located in the right-hand and left-hand sub-housings 8 and 9, respectively, for illuminating a number plate (not shown), which would carry the registration number of the prime mover, and which would be located on the rear panel 10 of the trailer 3 between the right-hand and left-hand sub-housings 8 and 9. Each fourth light source 19 comprises a plurality of fourth light emitting diodes 20 which are located in the right-hand and left-hand sub-housings 8 and 9 to direct light sidewardly from the sub-housings 8 and 9 towards a number plate located on a space 21 on the rear panel 10 of the trailer 3 between the right-hand and left-hand sub-housings 8 and 9.

Lenses (not shown) sealably mounted on the respective right-hand and left-hand sub-housings 8 and 9 sealably protect the first light sources 12, the second light sources 14, the third light sources 17 and the fourth light sources 19 from the ingress of moisture and the like.

Before describing the right-hand and left-hand sub-housings 8 and 9 of the system 1 further, the primary housing 5 and the primary controller 6 and its function will first be described.

The primary housing 5 is adapted for locating in the prime mover, in a convenient location, for example, on the dashboard, although in certain cases, the primary housing 5 may be located in a glove box or the boot or trunk of the prime mover. The primary controller 6 comprises a signal processor, which in this embodiment of the invention is provided by a microcontroller. The primary controller 6 is configured to be connected into the CAN bus 22 of the prime mover, as will be described below, in order to detect and read signals on the CAN bus 22 indicative of activation of the direction indicators (not shown) of the prime mover, braking of the prime mover, and activation of the tail lights (not shown) of the prime mover.

The primary controller 6 is programmed to be responsive to signals on the CAN bus 22 indicative of activation of either one of the direction indicators of the prime mover for producing a direction indicator active signal, and also for producing an identifying signal, namely, an identity code indicative of the identity of the one of the right-hand and left-hand direction indicators of the prime mover which has been activated. The primary controller 6 is also programmed to be responsive to a signal on the CAN bus 22 indicative of braking of the prime mover to produce a braking active signal. Additionally, the primary controller 6 is programmed to be responsive to the signal indicative of activation of the tail lights of the prime mover for producing a tail light active signal.

A wireless transmitter 24 located in the primary housing 5 is operated under the control of the primary controller 6 to transmit the signals produced by the primary controller 6 for reception by the right-hand and left-hand housings 8 and 9, namely, the direction indicator active signal and the identity code of the active direction indicator of the prime mover, the braking active signal, and the tail light active signal. In this embodiment of the invention the wireless transmitter 24 comprises a short range transmitter, and transmits the signals under the control of the primary controller 6 using a W-Fi protocol.

The primary controller 6 is also programmed to be responsive to signals on the CAN bus 22 being indicative of deactivation of the direction indicator of the prime mover, ceasing of braking of the prime mover and deactivation of the tail lights of the prime mover to produce an appropriate one of a direction indicator ceased signal, a braking ceased signal and a tail light ceased signal, as the case may be. The primary controller 6 also operates the wireless transmitter 24 to transmit the relevant one of the direction indicator ceased signal, the braking ceased signal and the tail light ceased signal.

A primary battery 25 located in the primary housing 5 powers the components in the primary housing 5.

The primary controller 6 is powered from a regulated voltage power supply 26, which in turn is powered by the primary battery 25. The wireless transmitter 24 is powered directly by the primary battery 25. The primary battery 25 may be a rechargeable battery or a disposable battery, although it is envisaged that the primary battery 25 may be dispensed with, and in such cases, it is envisaged that a plug adapted for connecting into an accessory power supply socket of the prime mover would be provided for powering the components of the primary housing 5.

A data input bus 28 extends from the primary controller 6 through the primary housing 5 and terminates in a plug 29 for connecting to a corresponding socket 30 of the CAN bus 22 of the prime mover. The plug 29 of the data input bus 28 of the primary housing 5 is connected to the socket 30 of the CAN bus 22 of the prime mover for detecting the signals on the CAN bus 22 indicative of activation of the direction indicators of the prime mover, braking of the prime mover and activation of the tail lights of the prime mover.

Referring now to the right-hand and left-hand sub-housings 8 and 9, a rechargeable secondary battery 33 is located in each of the right-hand and left-hand sub-housings 8 and 9 for powering the components in the corresponding sub-housing 8, 9. The first light source 12 of each right-hand and left-hand sub-housing 8 and 9 is powered by the secondary battery 33 through a corresponding first relay 35 which is located in the corresponding one of the right-hand and left-hand sub-housings 8 and 9. The second light source 14 of each of the right-hand and left-hand sub-housings 8 and 9 is powered by the corresponding secondary battery 33 through a second relay 36, which is also located in the corresponding one of the right-hand and left-hand sub-housings 8 and 9. The third and fourth light sources 17 and 19 of each left-hand and right-hand sub-housing 8, 9 are powered by the corresponding secondary battery 33 through a third relay 37 which is located in the corresponding one of the right-hand and left-hand sub-housings 8 and 9.

Each sub-housing 8 and 9 comprises a secondary controller 39 which is housed in the corresponding one of the sub-housings 8 and 9. The secondary controllers 39 for the right-hand and left-hand sub-housings 8 and 9 are identified by the reference numerals 39a and 39b, respectively, and each comprises a signal processor, in this case a microcontroller. Wireless receivers 40a and 40b located in the respective right-hand and left-hand sub-housings 8 and 9 are configured to operate in the Wi-Fi protocol and are tuned to receive signals in the Wi-Fi protocol transmitted by the wireless transmitter 24 of the primary housing 5 under the control of the primary controller 6.

Each secondary controller 39 is programmed to read signals received by the corresponding one of the wireless receivers 40, and to appropriately operate one or more of the corresponding first, second and third relays 35, 36 and 37, respectively, on receipt by the corresponding wireless receiver 40 of one or more of the direction indicator active signal and the direction indicator identity code, the braking active signal and the tail light active signal for in turn powering up the corresponding one or more of the first light source 12, the second light source 14 and the third and fourth light sources 17 and 19, as the case may be, or on receipt by the corresponding wireless receiver 40 of one or more of the direction indicator ceased signal, the braking ceased signal and the tail light ceased signal for deactivating the corresponding one or more of the first light source 12, the second light source 14 and the third and fourth light sources 17 and 19, as the case may be.

The secondary controllers 39 are programmed to operate the first relays 35 sequentially between the open and closed circuit states in order to cause the first light sources 12 to flash at a predefined rate until the direction indicator ceased signal has been received.

The secondary controller 39 of each one of the right-hand and left-hand sub-housings 8 and 9 is powered by the secondary battery 33 through a regulated voltage power supply 42 located in the corresponding one of the right-hand and left-hand sub-housings 8 and 9. The wireless receiver 40 of each one of the right-hand and left-hand sub-housings 8 and 9 is also powered by the corresponding secondary battery 33.

Each right-hand and left-hand sub-housing 8 and 9 comprises a photovoltaic solar panel 44 for charging the rechargeable secondary battery 33 of the corresponding one of the right-hand and left-hand sub-housings 8 and 9. A charge controller 45 located in each right-hand and left-hand sub-housing 8 and 9 regulates the charging of the corresponding rechargeable battery 33 by the corresponding solar panel 44. The solar panels 44 and the charge controllers 45 of the respective right-hand and left-hand sub-housings 8 and 9 are identified by the reference numerals 44a and 44b and 45a and 45b, respectively.

Although not illustrated, a suitable coupling means is provided on each of the right-hand and left-hand sub-housings 8 and 9 for coupling the sub-housings 8 and 9 to the rear panel 10 of the trailer 3. Such coupling means may, for example, comprise a permanent magnet, a strip of one of hooks and eyes, whereby the complementary one of the strip of the hooks and eyes would be provided on the rear panel 10 of the trailer 3 for securing the sub-housings 8 and 9 to the rear panel 10. Such hooks and eyes will be well known to those skilled in the art, and are sold under the Trade Mark VELCRO. Alternatively, a mechanical coupling means, for example, a clip mechanism, a toggle mechanism, vacuum suction pads or other mechanical fastening means, for example, screws and the like may be provided for coupling the right-hand and left-hand sub-housings 8 and 9 to the trailer 3.

In use, the plug 29 of the data input bus 28 of the primary housing 5 is connected to the socket 30 of the CAN bus 22 of the prime mover, and the primary housing 5 is located in any suitable or convenient location in the prime mover, so that the signals transmitted by the wireless transmitter 24 will be received by the wireless receivers 40 of the right-hand and left-hand sub-housings 8 and 9. The right-hand and left-hand sub-housings 8 and 9 are secured to the rear panel 10 by the appropriate releasable coupling means, the right-hand sub-housing 8 being located on the right-hand side of the rear panel 10 of the trailer 3 when viewed from the rear, and the left-hand sub-housing 9 being located on the rear panel 10 to the left-hand side thereof when viewed from the rear, with the space 21 left between the sub-housings 8 and 9 to accommodate a number plate with the registration number of the prime mover thereon. With the main housing 5 connected as described above and located in a convenient location in the prime mover and the right-hand and left-hand sub-housings 8 and 9 releasably secured to the trailer 3, the rear light system 1 is ready for use.

On the primary controller 6 detecting the signal on the CAN bus 22 indicative of activation of the tail lights of the prime mover, the primary controller 6 produces the tail light active signal and operates the wireless transmitter 24 to transmit the tail light active signal, which is received by the wireless receivers 40 of the respective right-hand and left-hand sub-housings 8 and 9. The secondary controllers 39 of the respective right-hand and left-hand sub-housings 8 and 9 on reading the tail light active signal received by the wireless receivers 40 of the right-hand and left-hand sub-housings 8 and 9 operates the third relays 37 of the corresponding right-hand and left-hand sub-housings 8 and 9 into the closed circuit state for in turn powering the third and fourth light sources 17 and 19. The third light emitting diodes 18 of the third light sources 17 of the respective right-hand and left-hand sub-housings 8 and 9 thereby form the tail lights of the trailer 3, while the fourth light emitting diodes 20 of the fourth light sources 19 of the respective right-hand and left-hand sub-housings 8 and 9 illuminate the space 21 on the rear panel 10 for illuminating a number plate thereon.

On the primary controller 6 detecting the signal indicative of the deactivation of the tail lights of the prime mover on the CAN bus 22, the primary controller 6 produces a tail light ceased signal and operates the wireless transmitter 24 to transmit the tail light ceased signal, which is received by the wireless receivers 40 of the right-hand and left-hand sub-housings 8 and 9. On the secondary controllers 39 of the right-hand and left-hand sub-housings 8 and 9 detecting the presence of the tail light ceased signal received by the corresponding wireless receivers 40, the secondary controllers 39 of the respective right-hand and left-hand sub-housings 8 and 9 operate the corresponding third relays 37 into the open circuit state, thereby powering down the third and fourth light sources 17 and 19.

The secondary controllers 39 of the respective right-hand and left-hand sub-housings 8 and 9 are programmed to retain the third relays 37 continuously in the closed circuit state once the tail light activate signal has been detected and until the tail light ceased signal has been detected.

On the primary controller 6 detecting the presence of a signal indicative of braking of the prime mover on the CAN bus 22 of the prime mover, the primary controller 6 produces the braking active signal and operates the wireless transmitter 24 to transmit the braking active signal. On the secondary controllers 39 of the respective right-hand and left-hand sub-housings 8 and 9 detecting receipt by the corresponding wireless receivers 40, the secondary controllers 39 operate the second relays 36 into the closed circuit state for powering the second light sources 14 of the respective right-hand and left-hand sub-housings 8 and 9.

On the primary controller 6 detecting that the signal indicative of braking of the prime mover has ceased on the CAN bus 22 of the prime mover, the primary controller 6 produces the braking ceased signal and operates the wireless transmitter 24 to transmit the braking ceased signal. On the secondary controllers 39 in the respective right-hand and left-hand sub-housings 8 and 9 detecting receipt by the corresponding wireless receivers 40 of the braking ceased signal, the secondary controllers 39 operate the corresponding second relays 36 into the open circuit state, thereby powering down the corresponding second light sources 14.

During the period between the secondary controllers 39 detecting the braking active signal and the braking ceased signal, the secondary controllers 39 retain the corresponding second relays 36 in the closed circuit state for continuously powering the second light sources 14a and 14b.

On the primary controller 6 detecting the signal indicative of activation of one of the direction indicators of the prime mover on the CAN bus 22, the primary controller 6 determines from the signal on the CAN bus 22 of the prime mover, which of the direction indicators of the prime mover the signal indicative of activation of the direction indicator is in respect of. The primary controller 6 then produces the direction indicator active signal together with the identifying code of the direction indicator which has been activated, and operates the wireless transmitter 24 to transmit the direction indicator active signal and the identifying code. On the secondary controllers 39 of the right-hand and left-hand sub-housings 8 and 9 detecting receipt by the wireless receivers 40, the secondary controllers 39 of each of the right-hand and left-hand sub-housings 8 and 9 read the identifying code to ascertain if the direction indicator activate signal relates to the secondary controller 39 of that one of the right-hand and left-hand sub-housings 8 and 9. On the secondary controller 39 determining that the received direction indicator activate signal is in respect of that one of the right-hand and left-hand sub-housings 8 and 9, that secondary controller 39 operates the corresponding first relay 35 sequentially between the open circuit and closed circuit states in order to cause the corresponding first light source 12 to flash at the predefined rate.

On the primary controller 6 detecting the signal indicative of deactivation of the direction indicator on the CAN bus 22 of the prime mover, the primary controller produces the direction indicator ceased signal and operates the wireless transmitter 24 to transmit the direction indicator ceased signal. The secondary controller 39 of the corresponding one of the right-hand and left-hand sub-housings 8 and 9 which had been operating the corresponding first relay 35 sequentially in the open and closed circuit states for flashing the corresponding first light source 12 on detecting the presence of the direction indicator ceased signal operates the first relay 35 into the open circuit state, thereby powering down the corresponding first light source 12.

When the trailer 3 is not being used, the sub-housings 8 and 9 are removed from the rear panel 10 of the trailer 3 and are stored in an appropriate place, for example, in the prime mover along with the primary housing 5.

The advantages of the invention are many. A particularly important advantage of the invention is that it provides rear lights for a towable vehicle without the need to have to hardwire the tail lights into the electrical circuitry of the prime mover by a plug and socket connection, which can readily easily become damaged.

Additionally, the rear light system is easily attached and fitted to a trailer and a prime mover. The primary housing can be readily coupled by the plug 29 into the socket of the CAN bus of the prime mover, and the right-hand and left-hand sub-housings 8 and 9 can be readily releasably secured to the rear panel of the trailer. When not in use, the primary housing and the two sub-housings can be readily easily stored in any convenient location, for example, in a glove box of the prime mover, the boot or trunk of the prime mover, or in any other suitable location, whether in the prime mover, or in the trailer or other towable vehicle, or remotely of the prime mover and the towable vehicle.

The provision of a solar panel in each sub-housing maintains the rechargeable batteries in the sub-housing charged, without the need to have to specifically plug the sub-housings into a battery charger charged by a mains power supply.

While the rear light system has been described as comprising a pair of sub-housings, each of which is provided with a secondary controller, a wireless receiver, a regulated power supply and a secondary battery, as well as a solar panel and a battery charge controller, it is envisaged in certain cases that a single secondary controller, a single wireless receiver, a single regulated power supply and a single secondary battery, as well as a single solar panel and batter control charger may be provided, and in which case, the secondary controller, the wireless receiver, the regulated power supply, the secondary battery, the solar panel and the battery charge controller would be located in a single trailer mountable housing, and only the first, second, third and fourth light sources and the first, second and third relays would be located in respective right-hand and left-hand sub-housings, which may be formed integrally with the trailer mountable housing or separately thereof. The first, second and third relays of the respective sub-housings would be hardwired from the sub-housings to the secondary controller.

It is also envisaged that the primary controller instead of being connected to the CAN bus, or as well as being connected to the CAN bus, may receive signals from a first sensor mounted on an operating arm of a direction indicator switch which would produce signals indicative of activation of the direction indicator switch, and the specific direction indicator being selected by the direction indicator switch. Typically, such a first sensor would be an accelerometer. Further, it is envisaged that a second sensor, such as a motion sensor may be provided for detecting braking of the prime mover, and the primary controller would read signals from the motion sensor in order to detect braking of the prime mover. Alternatively, it is envisaged that the primary controller may be hardwired into the brake light circuit and/or the direction indicator circuits for obtaining signals indicative of braking and activation of the direction indicators.

It is also envisaged that in certain cases, the primary controller may not be configured to receive signals indicative of braking of the prime mover, and in which case, a motion sensor or an accelerometer would be located in the sub-housings or in the trailer mountable housing to provide signals indicative of braking of the prime mover directly to the one or two secondary controllers, as the case may be, to indicate braking of the prime mover. It is also envisaged that a light sensor may be provided in the sub-housings or the secondary housing for controlling operation of the third and fourth light sources.

While the rear light system has been described for mounting on a trailer suitable for towing by a car, a van, truck or the like, it is envisaged that the rear light system may be used in connection with any prime mover and any towable vehicle, for example, a tractor, or indeed, the rear light system may be used in connection with a tractor unit and trailer unit of a combined articulated trailer. Such towable vehicles as well as comprising a trailer, may comprise a horsebox, a caravan, a boat trailer, or any other such towable vehicles.

It is also envisaged that a fifth light source may be provided in one or both of the sub-housings, which would act as a rear fog light. Each fifth light source would be operated under the control of the corresponding secondary controller in response to reception by the wireless receiver of an appropriate one of a fog light active signal and a fog light ceased signal transmitted by the wireless transmitter under the control of the primary controller. The primary controller would be programmed to produce the fog light active signal and the fog light ceased signal from signals derived from either the CAN bus or the electrical circuitry of the prime mover indicative of the rear fog light of the prime mover being activated or deactivated, as the case may be.

It is also envisaged that a sixth light source which would act as a reversing light could be provided in one or both of the sub-housings, and operation of the sixth light source would be similar to that described with reference to the fifth light source, with the exception that the signals produced by the primary controller and received by the secondary controllers would be produced in response to signals derived from the CAN bus of the prime mover or the electrical circuitry of the prime mover which would be indicative of the reversing light of the prime mover being activated or deactivated as the case may be.

1-57. (canceled)

58. A rear light system for a towable vehicle, the rear light system comprising a primary controller for locating in a prime mover by which the towable vehicle is being towed, the primary controller being configured to receive signals indicative of activation of a direction indicator of the prime mover, a wireless transmitter for locating in the prime mover and being configured to wirelessly transmit a direction indicator active signal under the control of the primary controller, a pair of first output elements adapted for mounting adjacent the rear of the towable vehicle spaced apart from each other and being configured to output a visually perceptible signal, a wireless receiver adapted for locating on the towable vehicle and being configured to wirelessly receive a direction indicator active signal transmitted by the transmitter, a secondary controller for locating on the towable vehicle and being configured to read a received direction indicator active signal from the receiver and to selectively activate the appropriate one of the first elements in response to the received signal.

59. A rear light system as claimed in claim 58 in which at least one second output element is provided adapted for mounting adjacent the rear of the towable vehicle and configured to output a visually perceptible signal.

60. A rear light system as claimed in claim 58 in which the primary controller is configured to receive a signal indicative of braking of the prime mover, and the secondary controller is responsive to a signal read from the wireless receiver to activate the second output means, and preferably, the primary controller is configured to receive the signal indicative of braking of the prime mover from a CAN bus of the prime mover, and advantageously, the primary controller is configured to receive the signal indicative of braking of the prime mover from a motion sensor located in the prime mover, and preferably, the motion sensor is provided and is electrically coupled to the primary controller.

61. A rear light system as claimed in claim 58 in which the primary controller is configured to receive the signal indicative of braking of the prime mover from a pedal state sensor operably connected to a brake pedal of the prime mover, and preferably, the pedal state sensor is provided and is electrically coupled to the primary controller.

62. A rear light system as claimed in claim 58 in which the primary controller is configured to receive the signal indicative of braking of the prime mover from a power signal derived from a brake light circuit of the prime mover, and preferably, the primary controller is responsive to the received signal indicative of braking of the prime mover to produce a braking active signal, and to operate the wireless transmitter to transmit the braking active signal, and preferably, the secondary controller is responsive to the braking active signal to activate the second output element to output the visually perceptible signal.

63. A rear light system as claimed in claim 58 in which the primary controller is responsive to ceasing of the signal indicative of braking of the prime mover to produce a braking ceased signal, and to operate the wireless transmitter to transmit the braking ceased signal, and preferably, the secondary controller is responsive to the braking ceased signal to deactivate the second output element.

64. A rear light system as claimed in claim 58 in which the primary controller is configured to receive the signal indicative of activation of a direction indicator of the prime mover from a CAN bus of the prime mover, and preferably, the primary controller is configured to receive the signal indicative of activation of a direction indicator of the prime mover from an operating arm state sensor mounted on an operating arm of a direction indicator switch of the prime mover, and preferably, the operating arm state sensor is provided, and is mounted on the operating arm of the direction indicator switch of the prime mover, and advantageously, the operating arm state sensor comprises an accelerometer, and preferably, the operating arm state sensor is electrically coupled to the primary controller.

65. A rear light system as claimed in claim 58 in which the primary controller is configured to receive the signal indicative of activation of a direction indicator of the prime mover from a power supply to the direction indicator of the prime mover, and preferably, the primary controller is responsive to the received signal indicative of activation of a direction indicator of the prime mover to produce the direction indicator active signal, and to operate the wireless transmitter to transmit the direction indicator active signal, and preferably, the secondary controller is responsive to the direction indicator active signal to activate one of the first output elements to output the visually perceptible signal.

66. A rear light system as claimed in claim 58 in which the primary controller is responsive to a signal indicative of the direction indicator of the prime mover being deactivated to produce a direction indicator ceased signal, and to operate the wireless transmitter to transmit the direction indicator ceased signal, and preferably, the secondary controller is responsive to the direction indicator ceased signal to deactivate the first output element.

67. A rear light system as claimed in claim 58 in which the primary controller is responsive to the received signal indicative of activation of a direction indicator of the prime mover to produce an identification signal identifying the direction indicator of the prime mover which has been activated, and to operate the wireless transmitter to transmit the identification signal, and preferably, the secondary controller is responsive to the identification signal to activate the appropriate one of the first output elements to output the visually perceptible signal.

68. A rear light system as claimed in claim 58 in which at least one third output element is provided and is adapted for locating adjacent the rear of the towable vehicle, the third output element being configured to output a visually perceptible signal, and preferably, at least one fourth output element is provided and is adapted for locating adjacent the rear of the towable vehicle and is configured to illuminate a panel adjacent the rear of the towable vehicle.

69. A rear light system as claimed in claim 58 in which the primary controller is configured to receive a signal indicative of activation of the tail lights of the prime mover, and the primary controller is responsive to the signal indicative of activation of the tail lights of the prime mover for producing a tail light active signal and for operating the wireless transmitter for transmitting the taillight active signal, and preferably, the secondary controller is responsive to the tail light active signal for activating the third output element and the fourth output element., and advantageously, the primary controller is configured to receive the signal indicative of activation of the tail lights of the prime mover from the CAN bus of the prime mover, and preferably, the primary controller is configured to receive the signal indicative of activation of the tail lights of the prime mover from a power signal derived from the tail light circuit of the prime mover.

70. A rear light system as claimed in claim 58 in which the primary controller is responsive to a signal indicative of deactivation of the tail lights for producing a tail light ceased signal and for operating the wireless transmitter for transmitting the tail light ceased signal, and preferably, the secondary controller is responsive to the tail light ceased signal for deactivating the third output element and the fourth output element, and advantageously, the wireless transmitter and the wireless receiver are configured to operate in a short range communications protocol, and preferably, the wireless transmitter and the wireless receiver are configured to operate under the Wi-Fi protocol.

71. A rear light system as claimed in claim 58 in which a primary power source is provided for powering the primary controller and the wireless transmitter, and preferably, the primary power source comprises a power source independent of any power source of the prime mover.

72. A rear light system as claimed in claim 58 in which at least one secondary power source is provided for powering the first output elements, the secondary controller and the wireless receiver, and preferably, the at least one secondary power source is provided for powering the second output element, and advantageously, the at least one secondary power source is provided for powering the third and fourth output elements.

73. A rear light system as claimed in claim 58 in which at least one trailer mountable housing is provided, and the secondary controller and the wireless receiver are housed in the trailer mountable housing, and preferably, the first output elements are housed in the trailer mountable housing, and advantageously, the at least one second output element is housed in the trailer mountable housing, and preferably, the third and fourth output elements are housed in the trailer mountable housing, and advantageously, the trailer mountable housing comprises a pair of sub-housings, and one of the first output elements is housed in each sub-housing, and preferably, a pair of the second output elements are provided, and one of the second output elements is housed in each sub-housing, and advantageously, a pair of the secondary controllers are provided and a pair of the secondary wireless receivers are provided, one of the secondary controllers and one of the wireless receivers being housed in each sub-housing, and preferably, a pair of the third output elements are provided, one of the third elements being located in each sub-housing, and advantageously, a pair of the fourth output elements is provided, each fourth output element being housed in one of the sub-housings.

74. A rear light system as claimed in claim 73 in which the sub-housings are adapted for mounting on the rear of the towable vehicle spaced apart from each other towards respective opposite sides of the towable vehicle, and preferably, each sub-housing is configured for releasable mounting on the towable vehicle.

75. A rear light system as claimed in claim 58 in which each first output element comprises a first light source, and preferably, each second output element comprises a second light source, and preferably, each third output element comprises a third light source, and advantageously, each fourth output element comprises a fourth light source.

76. A towable vehicle comprising the rear light system as claimed in claim 58.

77. In combination a prime mover and a towable vehicle, the towable vehicle comprising the rear light system as claimed in claim 58, and being hitched to the prime mover.
